(19) United States
(12) Patent Application Publication
(10) Pub. No.: US 2017/0298584 A1
(43) Pub. Date: Oct. 19, 2017

(54) Heated Platform Systems

(71) Applicant: Composite Advantage, LLC, Dayton, OH (US)

(72) Inventors: Scott R. Reeve, Dayton, OH (US); Andrew K. Loff, Huber Heights, OH (US)

(73) Assignee: Composite Advantage, LLC, Dayton, OH (US)

(21) Appl. No.: 15/485,731

(22) Filed: Apr. 12, 2017

Related U.S. Application Data
(60) Provisional application No. 62/322,016, filed on Apr. 13, 2016.

(51) Int. Cl. E01H 5/10; H05B 3/28

(52) U.S. Cl. CPC E01H 5/102; H05B 3/286; H05B 2214/02

(57) ABSTRACT

Heated platform systems are disclosed herein. Heated platform systems according to the present disclosure include a fiber reinforced panel that has a heating element that is made from a plurality of conductive mats. The plurality of conductive mats are placed into electrical continuity with one another by electrical leads, and are electrically isolated from one another by electrical insulating interleaf layers that prevent electrical shunting of adjacent conductive mats.

### CROSS-REFERENCE TO RELATED APPLICATIONS

The present application is a non-provisional of U.S. Provisional Appln. No. 62/322,016 filed Apr. 13, 2016 and titled “Heated Fiberglass Bridges and Platforms”, the entire disclosure of which is incorporated by reference herein.

### TECHNICAL FIELD

The present disclosure relates to heated platform systems, and, more specifically, to elevated platform systems having load bearing fiber reinforced panels heated by integrated resistive heating elements.

### BACKGROUND

Conventional infrastructure, for example, pedestrian or vehicle bridges, drilling platforms, and transportation waiting platforms, may be prone to accumulation of snow and ice. Such accumulation of moisture may be undesirable. Accordingly, heated platform systems may be desired.

### SUMMARY

According to a first embodiment, a heated platform system includes a base support structure and a deck coupled to the base support structure. The deck includes a fiber reinforced panel. The fiber reinforced panel includes an upward-oriented face having a top exterior surface, a downward-oriented face, and a core that separates the upward-oriented face from the downward-oriented face. The fiber reinforced panel includes a first heating element positioned closer to the upward-oriented face than to the downward-oriented face. The first heating element is at least partially embedded in a polymer such that the first heating element is spaced apart from the top exterior surface of the upward-oriented face. The first heating element comprises a first conductive mat and a second conductive mat. The first conductive mat and the second conductive mat are electrically connected to one another by an electrical lead. An electrical insulator interleaf layer is positioned over a portion of the first conductive mat and under a portion of the second conductive mat and laterally separates the first conductive mat from the second conductive mat to provide edge-wise electrical isolation of the first conductive mat and the second conductive mat without interrupting the electrical connection by the electrical lead.

According to a second embodiment, a platform system includes a base support structure and a deck coupled to the base support structure. The deck extends from a first abutment to a second abutment. The first abutment and the second abutment are positioned on opposite sides of a topographic area. The deck and the base support structure are elevated from the topographic area. The deck comprises a plurality of fiber reinforced panels that are arranged to extend from the first abutment to the second abutment. Each of the plurality of fiber reinforced panels includes a first heating element that is at least partially embedded in a polymer such that the first heating element is spaced apart from a top exterior surface of the fiber reinforced panel. The first heating element includes a first conductive mat and a second conductive mat. The first conductive mat and the second conductive mat are electrically connected to one another by an electrical lead. An electrical insulator interleaf layer is positioned over a portion of the first conductive mat and under a portion of the second conductive mat and laterally separates the first conductive mat from the second conductive mat to provide edge-wise electrical isolation of the first conductive mat and the second conductive mat without interrupting the electrical connection by the electrical lead.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 is a side perspective view of a heated platform system according to one or more embodiments shown or described herein;

FIG. 2 is a side sectional view of the heated platform system taken along line 2-2 of FIG. 1;

FIG. 3 is a detailed side sectional view of the heated platform system taken along view 3 of FIG. 2;

FIG. 4 is a detailed side sectional view of the heated platform system taken along view 4 of FIG. 2;

FIG. 5 is a partial top view of the heated platform system taken along view 5 of FIG. 1;

FIG. 6 is a schematic view of a heated platform system having a control panel according to one or more embodiments shown or described herein;

FIG. 7 is a side perspective view of a heated platform system according to one or more embodiments shown or described herein;

FIG. 8 is a side perspective view of a heated platform system according to one or more embodiments shown or described herein; and

FIG. 9 is a side view of a heated platform system according to one or more embodiments shown or described herein.

### DETAILED DESCRIPTION

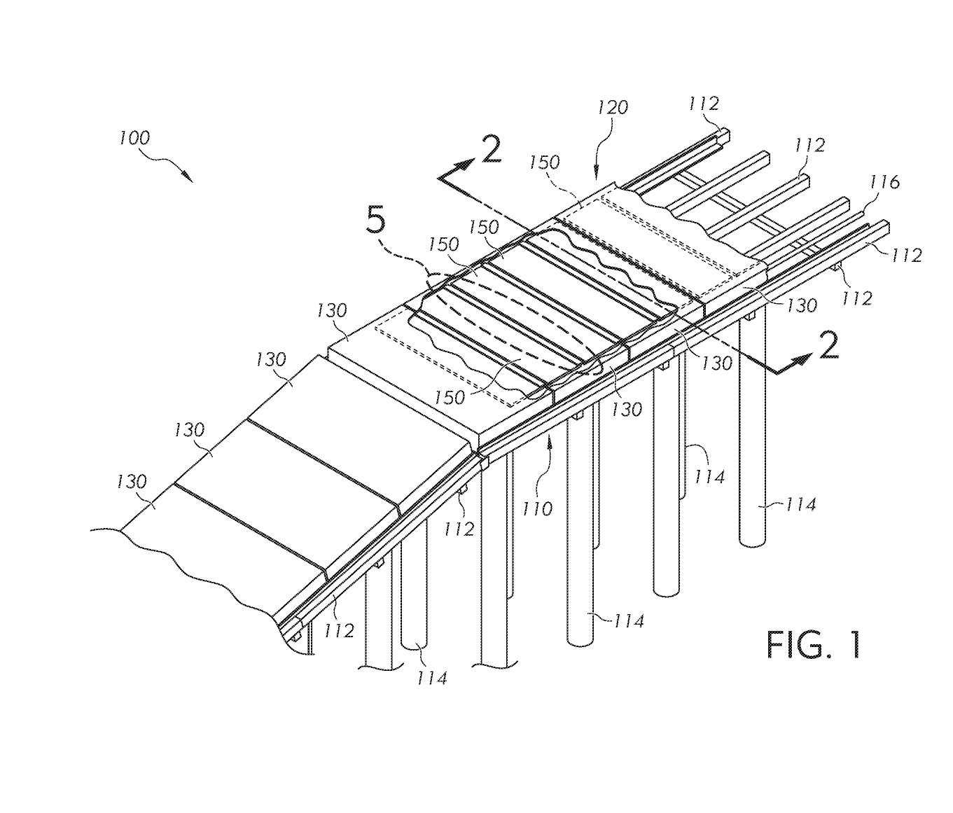

Referring to FIG. 1, a heated platform system 100 having a base support structure 110 and a deck 120 that is coupled to the base support structure 110. The deck 120 includes a plurality of fiber reinforced panels 130 that are arranged to form a traversable surface of the heated platform system 100. The fiber reinforced panels 130 include at least one heating element 150. The heating elements 150 are positioned to introduce heat to the fiber reinforced panels 130 as to warm a top surface of the fiber reinforced panels 130, thereby melting accumulated snow or ice and/or preventing the accumulation of snow or ice on the top surface of the fiber reinforced panels. These and other elements will be discussed in further detail below.

In general, heated platform systems according to the present disclosure may sufficiently warm the top surface of the deck that is formed from the fiber reinforced panels. To maintain reasonable manufacturing costs while preserving flexibility in design and manufacturing of the heated platform system, the heating elements may incorporate conductive mats of various shape and configuration. The conductive mats may be combined into a desired shape and size to provide heat across fiber reinforced panels of a prescribe shape and size. Once combined, these different shaped conductive mats, however, may exhibit different resistances within a particular fiber reinforced panel. To reduce high or low temperature regions across the fiber reinforced panel, the conductive mats may be electrically isolated from one another by an electrical insulator interleaf layer that is positioned between conductive mats that are positioned next to one another. The conductive mats of a heating element are placed into electrical conductivity with one another by electrical leads that can control the flow of power from one conductive mat to another and create a combination of resistance to provide consistent temperatures across the panel surface.

Additionally, the heating elements across the heated platform system may be controlled from a control panel that selectively delivers power to the heating elements along the heated platform system. The control panel may direct power to the heating elements according to a duty cycle. The use of the duty cycle allows for proper power delivery to each of the heating elements but maintains the current drawn by the entire heated platform system below a threshold value, such that the heated platform system does not overdraw a power source remains cost-effective. This may be particularly important for applications in which the heated platform system is installed in a remote location that is located far away from a main power supply.

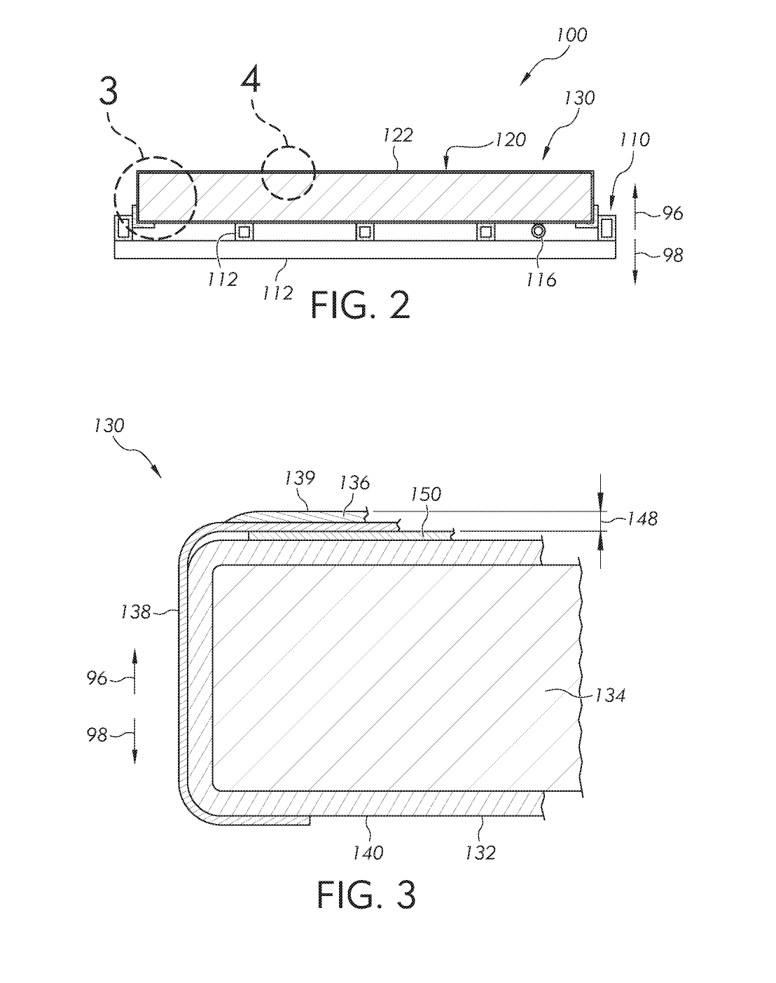

Referring again to FIG. 1, the heated platform system 100 includes a base support structure 110 and the deck 120 that is coupled to the base support structure 110. In the depicted embodiment, the base support structure 110 includes a plurality of hollow structural section members 112 that are arranged to provide support to the deck 120. In various embodiments, the base support structure 110 may include I-beams, C-channel, (not shown) or angle bar (see FIG. 2), which provides support to the deck 120. In embodiments in which the deck 120 is positioned in an elevated position from the ground surface, the base support structure 110 may include posts 114 that provide support to the hollow structural section members 112. In embodiments in which the deck is positioned proximate to the ground surface, the base support structure may include curbs, including poured concrete curbs, which provide support to the deck 120.

The heated platform system may be used in a variety of end-user application including, for example and without limitation, as a pedestrian walkway, as a public transportation platform, as an elevated drilling platform, and as a bridge for pedestrian and/or vehicular travel.

The deck 120 includes a plurality of fiber reinforced panels 130 that are arranged to form a traversable surface 122 of the deck 120. The fiber reinforced panels 130. The fiber reinforced panels 130 include at least one heating element 150 that is positioned proximate to the traversable surface 122 of the deck 120. The heating elements 150, which are described in greater detail below, provide selective heating to the fiber reinforced panels 130 and prevent the accumulation of snow and ice along the traversable surface 122 of the deck 120.

Referring now to FIG. 2, a sectional view of the heated platform system 100 is depicted. In the depicted embodiment, the fiber reinforced panel 130 is supported on the base support structure 110 that includes a plurality of hollow structural section members 112. The base support structure 110 and the fiber reinforced panels 130 may be arranged to provide the traversable surface 122, which is positioned along the fiber reinforced panels 130 in a direction towards an upward-oriented face 96. In the depicted embodiment, the base support structure 110 is positioned in a direction towards a downward-oriented face 98 relative to the base support structure 110. The heated platform system 100 also includes a conduit 116 that is coupled to one of the base support structure 110 or the fiber reinforced panels 130. The conduit 116 provides protection to electrical services that are delivered to the fiber reinforced panels 130 for heating. The conduit 116 may also provide protection to electrical services that are delivered to lighting fixtures (not shown) that are positioned along the heated platform system 100.

In general, the fiber reinforced panels include a composite structure that includes a polymer and a fiber that are positioned around a core material. In the depicted embodiments, the polymer and the fiber are typically depicted as coincident with one another. Fiber reinforced panels are generally corrosion resistant to chemicals and water, and require reduced maintenance as compared conventional decking materials. Fiber reinforced panels are generally lighter weight than conventional decking materials, which simplifies installation and reduces the load bearing requirements, and therefore cost, of superstructures and substructures with which fiber reinforced panels are used. Additionally, flexibility of manufacturing fiber reinforced panels allows for fiber reinforced panels to be customized to a particular installation site, including by customizing the size, shape and crown of the fiber reinforced panels.

Referring now to FIG. 3, construction of one fiber reinforced panel 130 is depicted in greater detail. The fiber reinforced panel 130 includes a core 134, examples of which include open cell foam or closed cell foam made from, for example, polyethylene, polystyrene, or polyvinyl chloride, balsa, or various honeycomb structures. The core 134 is surrounded by a reinforcement layer 132 that is generally rigid and surrounds the core 134 along the upward-oriented face 96 and the downward-oriented face 98 of the fiber reinforced panel 130. The reinforcement layer 132 includes a polymer, for example, various thermoset resins, and a fabric reinforcement, for example fiberglass, carbon fiber, or combinations thereof.

The fiber reinforced panel 130 also includes a heating element 150 that is encapsulated within the fiber reinforced panel 130. The heating element 150 is made from a material that is generally electrically conductive, but has sufficient resistance to generate heat when electricity is conveyed through the heating element 150. Such materials may include, for example, carbon fiber or a metallic mesh, which are conventionally known to be used as resistive heating elements. The heating element 150 is encapsulated by an insulating wrap layer 138 that is positioned in a direction towards the upward-oriented face 96 relative to the heating element 150. The insulating wrap layer 138 may eliminate contact between a user of the fiber reinforced panel 130 and the heating element 150. In one embodiment, the insulating wrap layer 138 may include an insulating fiber, for example, fiber glass, and a polymer. Additionally, the core 134 may be an insulator, which may therefore direct the majority of the heat from the heating element 150 towards the upward-oriented face 96 of the fiber reinforced panel 130.

The depicted fiber reinforced panel 130 also includes a wear surface 136 that is positioned towards the upward-oriented face 96 relative to the insulating wrap layer 138. The wear surface 136 defines the top exterior surface 139 of the fiber reinforced panel 130. The wear surface 136 may include a texture that enhances a non-slip property of the fiber reinforced panel 130.

Additionally, the fiber reinforced panel 130 may include a variety of attachment structures (not shown) that are embedded within the fiber reinforced panel 130 that allow for attachment of the fiber reinforced panel 130 to the base support structure 110. For example, plates made of, for example, steel, aluminum, or polymer, may be embedded within the fiber reinforced panel 130, and may allow for fastening of the fiber reinforced panel 130 to the base support structure 110.

As depicted in FIG. 3, the construction of the fiber reinforced panel 130 defines a distance 148 between the top exterior surface 139 of the fiber reinforced panel 130, as defined by the wear surface 136, and the top surface of the heating element 150.

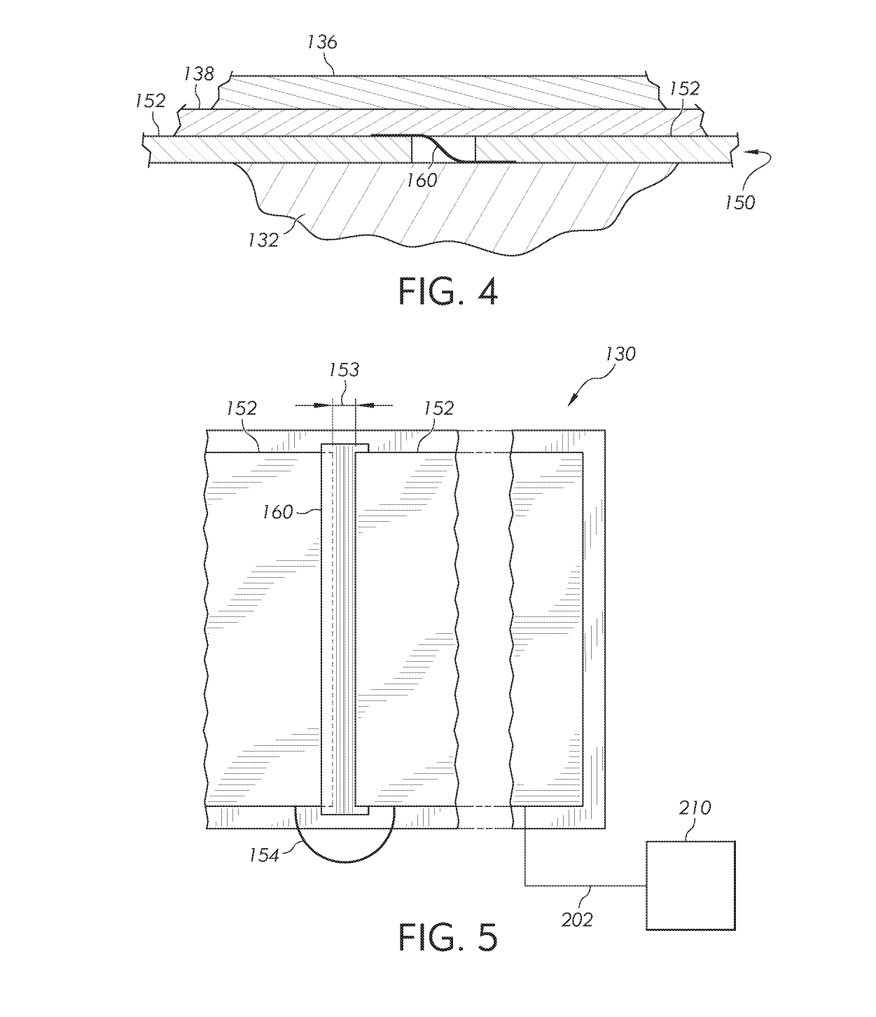

Referring now to FIGS. 4 and 5, the heating element 150 may include a plurality of conductive mats 152. In the depicted embodiment, the heating element 150 includes a first and a second conductive mat 152. The first conductive mat 152 and the second conductive mat 152 may be separated from one another by an electrical insulator interleaf layer 160. The electrical insulator interleaf layer 160 is positioned over a portion of the first conductive mat 152 and under a portion of the second conductive mat 152 and laterally separates the first conductive mat 152 from the second conductive mat 152 to provide edge-wise electrical isolation of the first conductive mat 152 and the second conductive mat 152.

The plurality of conductive mats 152 are placed into electrical conductivity with one another by electrical leads 154. In the depicted embodiment, the electrical leads 154 are attached to the conductive mats 152 in a targeted location that is proximate to the ends of the conductive mats 152. Electrical power may be delivered from a remotely-positioned power source 210 that is placed into electrical continuity with the plurality of conductive mats 152 by a wiring harness 202. In various embodiments, the conductive mats 152 may be designed to distribute power evenly along the conductive mat 152 when power is directed through these locations. However, if the conductive mats 152 are allowed to come into electrical continuity with one another at locations other than these targeted locations, the conductive mats 152 have a tendency to shunt the electrical heating circuit. This shunting of the electrical heating circuit will affect the distribution of electrical power through the heating element 150, which may lead to localized hot and cold spots throughout the heating element 150. To avoid such localized hot and cold spots, the electrical insulator interleaf layer 160 electrically isolates adjacent conductive mats 152 without interrupting the electrical conductivity between the conductive mats 152 that is formed by the electrical leads 154.

In various embodiments, the electrical insulator interleaf layer 160 may include fiber glass. In one embodiment, the electrical insulator interleaf layer 160 may have a thickness of at least 0.030 inches. In one embodiment, the electrical insulator interleaf layer 160 may laterally separate the first and second conductive mats 152 by a lateral distance 153. To minimize the local variations in the heat that is directed to the top exterior surface 139 of the fiber reinforced panel 130, the lateral distance 156 between conductive mats 152 may be minimized. In one embodiment, the lateral distance 156 between a first conductive mat 152 and a second conductive mat 152 is less than 10 times the distance 148 between the top exterior surface 139 of the fiber reinforced panel 130 and the top surface of the first conductive mat 152, for example, being less than 7 times the distance 148, for example, being less than 5 times the distance 148.

Referring collectively to FIGS. 3-5, the fiber reinforced panels 130 may be manufactured using a lay-up construction technique. In one example, manufacturing may begin with a tool that defines the exterior shape of the fiber reinforced panel 130 that is to be produced. Component layers representing the layers of the fiber reinforced panel 130 construction may be placed within the tool, starting with the insulating wrap layer 138, then the heating element 150 (including the plurality of conductive mats 152 that are separated by electrical insulator interleaf layers 160 and connected by electrical leads 154), followed by the reinforcement layer 132 and the core 134. The component layers may be first wetted with a non-cross-linked resin, which is allowed to cure and cross-link once the component layers are assembled. In other embodiments, the component layers may be assembled into the tool without the presence of a resin. Once the component layers are fully assembled, a non-cross-linked resin may be infused into the tool with a vacuum, thereby wetting the component layers of the fiber reinforced panel 130. The wear surface 136 may then be applied to the fiber reinforced panel 130 above the insulating wrap layer 138.

In various embodiments, the manufacturing techniques may be modified to provide the required flexibility of manufacturing along with the desired strength and durability of the resultant fiber reinforced panel 130.

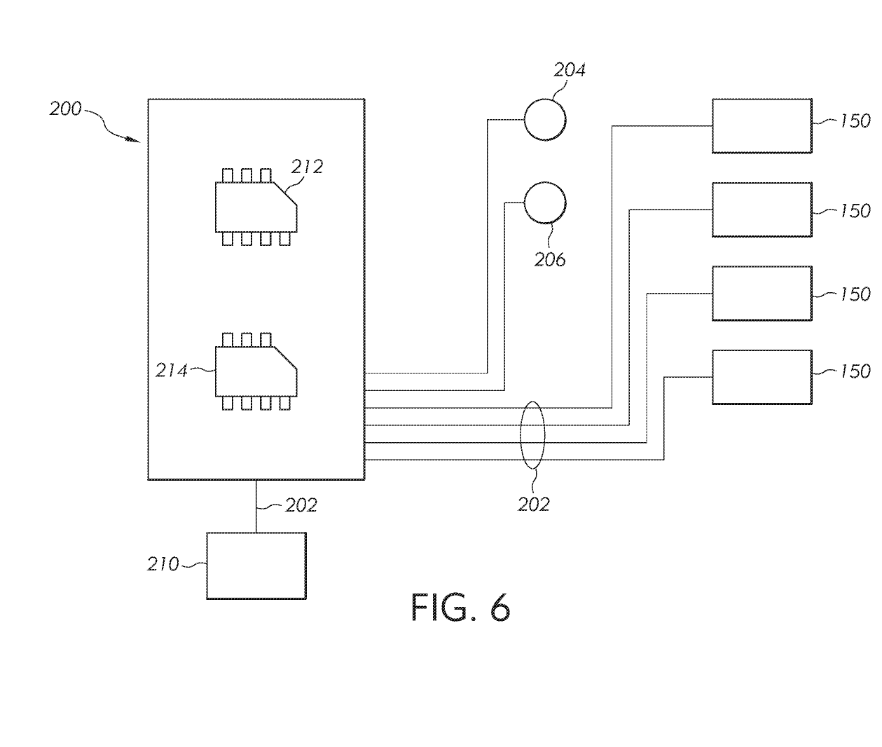

Referring now to FIG. 6, a control panel 200 for the heated platform system is depicted. In the depicted embodiment, the control panel 200 includes a processor 212 and a memory 214, for example, a non-volatile memory. The control panel 200 may be connected to a power source 210 that is positioned remotely from the heated platform system. The power source 210 may be placed into electrical continuity with the control panel 200 and the heating elements 150 of the heated platform system by a wiring harness 202. The control panel 200 may also include a temperature sensor 204 and a moisture sensor 206 that are positioned proximate to the heated platform system. In various embodiments, the control panel 200 may include a plurality of temperature sensors 204 that senses an ambient temperature and/or a deck temperature of the heated platform system. In various embodiments, the control panel 200 may include a plurality of moisture sensors 206 to determine the present or absence of moisture at various locations along the heated platform system.

The memory 214 includes a computer readable instruction set that a memory storing a computer readable instruction set that, when executed by the processor, manages power distribution of the heated platform system. The control panel directs power to the plurality of heating elements 150 that are positioned along the deck of the heated platform system according to a duty cycle to maintain power draw at or below a current capacity of the power source 210. The duty cycle applies power to a first heating element 150 that is positioned along a deck of the heated platform system. The control panel 200 determines if a first predetermined event of a temperature condition or a time duration has been satisfied. The control panel 200 then removes power from the first heating element 150 and applies power to a second heating element 150 that is positioned along the deck of the heated platform system. The control panel 200 determines if a second predetermined event of a temperature condition or a time duration has been satisfied. The control panel 200 then removes power from the second heating element 150 and applies power to the first heating element 150.

The control panel 200 evaluates the first predetermined event and the second predetermined event such that power is directed to the first heating element and the second heating element according to the duty cycle such that a thermal capacitance of the deck maintains the surface temperature of the deck above a temperature at which snow and ice will not accumulate on the deck of the heated platform system throughout the duty cycle, for example by maintaining a temperature of at least 32° F. along the top exterior surface of each of the fiber reinforced panels throughout the duty cycle.

The computer readable instruction set that is stored in the memory 214 of the control panel 200 may include logic that determines if accumulation of moisture is likely to occur given the temperature and moisture conditions. Before initiating the duty cycle, the control panel evaluates the ambient temperature sensor and the ambient moisture sensor to determine that ambient weather conditions are within a range corresponding to accumulation of moisture on the deck. The control panel 200 may only initiate the duty cycle when these ambient weather conditions are present.

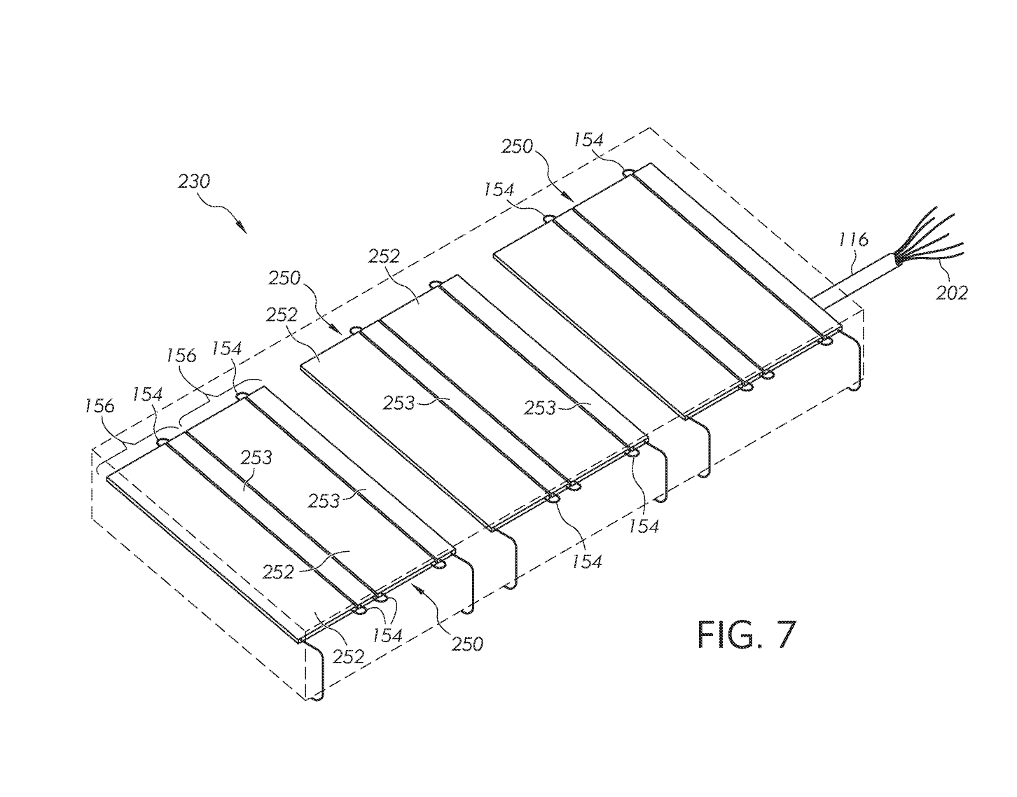

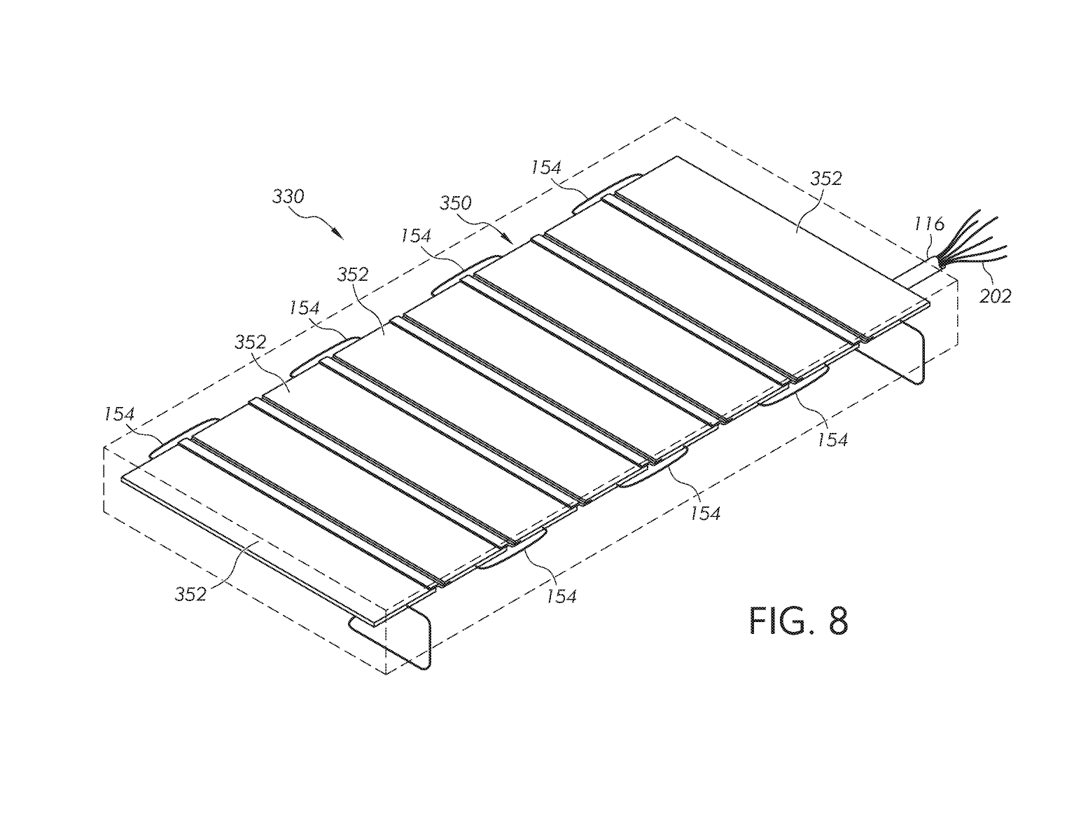

Referring now to FIGS. 7 and 8, variations in fiber reinforced panels 230, 330 are depicted. As depicted in FIG. 7, a fiber reinforced panel 230 may include a plurality of heating elements 250 that are arranged along the fiber reinforced panel 230. These heating elements 250 may be connected back to the control panel (as shown in FIG. 6) through electrical connections with the wiring harness 202. In some embodiments, portions of the electrical connection may be embedded within the fiber reinforced panel 230, and electrical leads may be collected and attached to the wiring harness 202 that is positioned within the conduit 116.

The flexibility in manufacturing the fiber reinforced panels 230 is advantageous to accommodate various configurations of end-use installations. However, to manage costs and inventory of components used in manufacturing of the fiber reinforced panels 230, it may be desirable to use commercially available components. For example, the conductive mats 252, 253 that are assembled into the heating elements 250 may be commonly available in discrete sizes. To assemble a heating element 250 that is of appropriate size for the fiber reinforced panel 230, conductive mats 252, 253 having differing size may be assembled to form a heating element 250. Because of the difference between the conductive mats 252, 253, including differences in size and conductivity, the conductive mats 252, 253 may be electrically connected in series or in parallel with one another to even resistance, thereby evening heat distribution, across the heating element 250. In the depicted embodiment, first conductive mats 252 and second conductive mats 253 of differing size are electrically connected to one another with electrical leads 154 in parallel, thereby defining a heating element subassembly 158. Placing the conductive mats 252, 253 into electrical continuity with one another in such a manner may even the resistance across the heating element 250. A plurality of these heating element subassemblies 158 are electrically connected to one another with electrical leads 154 in series, thereby forming the heating element 250. When assembled into the heating element 250, the plurality of conductive mats 252, 253 may exhibit a local resistance that is within 10% of an average resistance of the plurality of conductive mats 252, 253 across the heating element 250. Even resistance across the heating element 250 will lead to even heating across the fiber reinforced panel.

Note that in FIG. 7, the electrical insulator interleaf layers have not been depicted as positioned between the adjacent conductive mats 252, 253 to maintain clarity of the drawing. It should be understood that the plurality of conductive mats 252, 253 that are assembled into the heating elements 250 are separated from one another by electrical insulator interleaf layers, which prevent shunting across the adjacent conductive mats 252, 253. Additionally, while not depicted in FIG. 7, electrical insulator interleaf layers may be positioned between adjacent heating elements 250, as required to satisfy the heating element 250 functionality, such that the heating elements 250 that are positioned with the fiber reinforced panel 230 are electrically isolated from one another such that the adjacent heating elements 250 do not shunt one another and such that the adjacent heating elements 250 may be operated without regard to operation of the surrounding heating elements 250.

Referring to FIG. 8, in an alternative to the conductive mat arrangement depicted in FIG. 7, if the heating element 350 is assembled from conductive mats 352 that are placed into electrical continuity with one another by electrical leads 154 exhibit generally the same resistance, the conductive mats 352 may be placed into electrical continuity in a series arrangement with one another.

Note that, in regard to the orientation between the heating elements 150, 250, 350 and the structure of the fiber reinforced panels 130, 230, 330, as depicted in FIGS. 1-5, 7, and 8, the relative orientation of any of the components may be modified without departing from the scope of the present disclosure. Accordingly, the depicted orientations of the heating elements 150, 250, 350 and the structure of the fiber reinforced panels 130, 230, 330 should not be interpreted to limit the scope of the present disclosure.

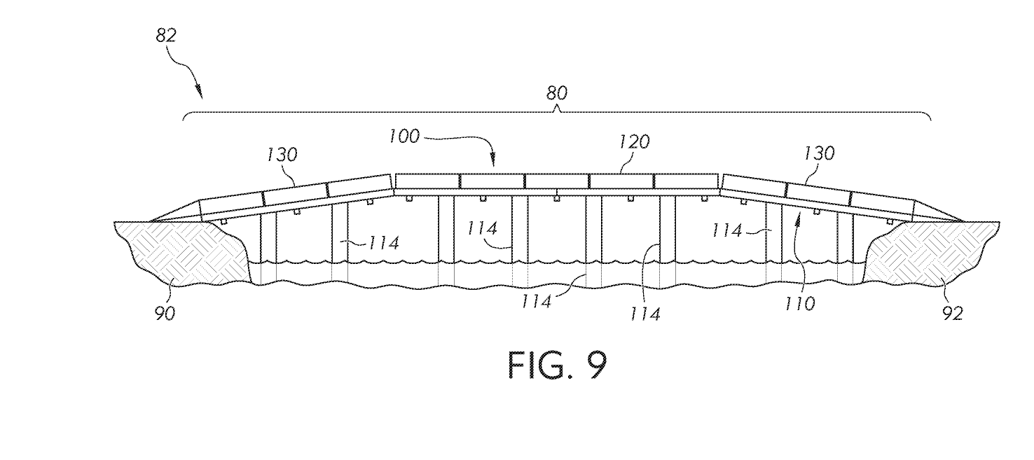

Referring now to FIG. 9, one use case of the heated platform system 100 is depicted. In the depicted embodiment, the heated platform system 100 arranged as a bridge 82 in which the deck 120 extends from a first abutment 90 to a second abutment 92. The first abutment 90 and the second abutment 92 are positioned on opposite sides of a topographic area 80. The deck 120 and the base support structure 110 are elevated from the topographic area 80. As discussed hereinabove, the deck 120 comprises a plurality of fiber reinforced panels 130. In the depicted embodiment, the base support structure 110 is supported by posts 114 that are positioned within the topographic area 80, however, the design of the base support structure may be modified to reduce a necessity for posts 114 within the topographical area 80.

It should now be understood that heated platform systems according to the present disclosure include a fiber reinforced panel that has a heating element that is made from a plurality of conductive mats. The plurality of conductive mats are placed into electrical continuity with one another by electrical leads, and are electrically isolated from one another by electrical insulating interleaf layers that prevent electrical shunting of adjacent conductive mats. The incorporation of the electrical insulating interleaf layers may provide more even resistance across the heating element, thereby providing even heating across the fiber reinforced panel in which the heating element is assembled.

It is also noted that recitations herein of “at least one” component, element, etc., should not be used to create an inference that the alternative use of the articles “a” or “an” should be limited to a single component, element, etc.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A heated platform system comprising a base support structure and a deck coupled to the base support structure, wherein:
the deck comprises a fiber reinforced panel, the fiber reinforced panel comprising an upward-oriented face having a top exterior surface, a downward-oriented face, and a core that separates the upward-oriented face from the downward-oriented face;
the fiber reinforced panel comprises a first heating element positioned closer to the upward-oriented face than to the downward-oriented face;
the first heating element is at least partially embedded in a polymer such that the first heating element is spaced apart from the top exterior surface of the upward-oriented face;
the first heating element comprises a first conductive mat and a second conductive mat;
the first conductive mat and the second conductive mat are electrically connected to one another by an electrical lead; and
an electrical insulator interleaf layer is positioned over a portion of the first conductive mat and under a portion of the second conductive mat and laterally separates the first conductive mat from the second conductive mat to provide edge-wise electrical isolation of the first conductive mat and the second conductive mat without interrupting the electrical connection by the electrical lead.

2. The heated platform system of claim 1, wherein the electrical insulator interleaf layer comprises fiberglass.

3. The heated platform system of claim 2, wherein the electrical insulator interleaf layer separates the first conductive mat from the second conductive mat by distance of at least 0.030 inches.

4. The heated platform system of claim 1, wherein:
the first conductive mat differs in size from the second conductive mat; and
the first conductive mat and the second conductive mat are electrically connected in parallel with one another by the electrical lead.

5. The heated platform system of claim 4, wherein:
the first conductive mat and the second conductive mat form a heating element subassembly;
the heating element comprises a plurality of heating element subassemblies; and
the heating element subassemblies within the heating element are electrically connected in series with one another by the electrical leads.

6. The heated platform system of claim 1, wherein:
the first conductive mat and the second conductive mat are sized approximately the same; and
the first conductive mat and the second conductive mat are electrically connected in series with one another by the electrical leads.

7. The heated platform system of claim 1, wherein the electrical insulator interleaf layer eliminates shunting between the first conductive mat and the second conductive mat at locations other that the electrical connection of the electrical lead.

8. The heated platform system of claim 1, wherein an insulating wrap layer is positioned between the first heating element and the top exterior surface of the fiber reinforced panel.

9. The heated platform system of claim 1, further comprising a second heating element comprising a plurality of conductive mats.

10. The heated platform system of claim 9, wherein the first heating element and the second heating element are incorporated into the fiber reinforced panel.

11. The heated platform system of claim 9, wherein the first heating element is incorporated into the fiber reinforced panel and the second heating element is incorporated into a second fiber reinforced panel.

12. The heated platform system of claim 1, wherein the deck is elevated from a ground surface.

13. The heated platform system of claim 1, further comprising a conduit coupled to at least one of the deck or the base support structure.

14. The heated platform system of claim 1, wherein each of the plurality of conductive mats exhibits a local resistance that is within 10% of an average resistance of the plurality of conductive mats across the fiber reinforced panel.

15. The heated platform system of claim 1, wherein a lateral distance between the first conductive mat and the second conductive mat is less than 10 times a distance from the first conductive mat to the top exterior surface of the fiber reinforced panel.

16. The heated platform system of claim 1, further comprising:
the deck extends from a first abutment to a second abutment;
the first abutment and the second abutment are positioned on opposite sides of a topographic area;
the deck and the base support structure are elevated from the topographic area; and
the deck comprises a plurality of fiber reinforced panels that are arranged to extend from the first abutment to the second abutment.

17. The heated platform system of claim 1, further comprising a control panel having a processor and a memory storing a computer readable instruction set that, when executed by the processor, manages power distribution of the heated platform system by:
directing power to a plurality of heating elements that are positioned along the deck of the heated platform system according to a duty cycle to maintain power draw at or below a current capacity of a power source, the duty cycle comprising:
applying power to the heating element, wherein the heating element is in electrical conductivity with the power source;
determining that a first predetermined event of a temperature condition or a time duration has been satisfied;
removing power from the heating element;
applying power to a second heating element that is positioned along the deck of the heated platform system, wherein the second heating element is in electrical conductivity with the power source and the first heating element and the second heating element are electrically isolated from one another;
determining that a second predetermined event of a temperature condition or a time duration has been satisfied;
removing power from the second heating element; and
applying power to the heating element.

18. The heated platform system of claim 17, wherein first predetermined event and the second predetermined event are selected such that power is directed to the first heating element and the second heating element according to the duty cycle such that a thermal capacitance of the deck maintains the surface temperature of the deck above 32° F. throughout the duty cycle.

19. The heated platform system of claim 17, further comprising an ambient temperature sensor and an ambient moisture sensor,
wherein the control panel, before initiating the duty cycle, evaluates the ambient temperature sensor and the ambient moisture sensor to determine that ambient weather conditions are within a range corresponding to accumulation of moisture on the deck.

20. A heated platform system comprising a base support structure and a deck coupled to the base support structure, wherein:
the deck extends from a first abutment to a second abutment;
the first abutment and the second abutment are positioned on opposite sides of a topographic area;
the deck and the base support structure are elevated from the topographic area;
the deck comprises a plurality of fiber reinforced panels that are arranged to extend from the first abutment to the second abutment; and
each of the plurality of fiber reinforced panels comprise a first heating element that is at least partially embedded in a polymer such that the first heating element is spaced apart from a top exterior surface of the fiber reinforced panel, wherein:
the first heating element comprises a first conductive mat and a second conductive mat;
the first conductive mat and the second conductive mat are electrically connected to one another by an electrical lead; and
an electrical insulator interleaf layer is positioned over a portion of the first conductive mat and under a portion of the second conductive mat and laterally separates the first conductive mat from the second conductive mat to provide edge-wise electrical isolation of the first conductive mat and the second conductive mat without interrupting the electrical connection by the electrical lead.
